(19) United States
(12) Patent Application Publication
(10) Pub. No.: US 2023/0104014 A1
(43) Pub. Date: Apr. 6, 2023

(54) Tablet case

(71) Applicant: Xiaoying Zhan, Anqing (CN)

(72) Inventor: Xiaoying Zhan, Anqing (CN)

(21) Appl. No.: 18/079,037

(22) Filed: Dec. 12, 2022

(30) Foreign Application Priority Data
Oct. 18, 2022 (CN) 202222739739.7

(51) Int. Cl. G06F 1/16

(52) U.S. Cl. CPC G06F 1/1656; G06F 2200/1633

(57) ABSTRACT

The present disclosure provides a tablet case, and relates to the technical field of tablet cases. The tablet case includes a case body and a soft rubber side cover; a buckle cover is mounted on a surface of the case body; an insertion slot is formed in an outer side of the case body; an extension plate is fixedly arranged on a surface of the soft rubber side cover; one side of the extension plate is fixedly provided with an insertion rod. In addition, to mount the soft rubber side cover again, the user simply inserts the insertion rod into the insertion slot and can reuse the soft rubber side cover. The whole process is easy and fast, and the tablet case is convenient to use and can meet a use demand of the user.

### TECHNICAL FIELD

The present disclosure relates to the technical field of tablet cases, in particular, to a tablet case.

### BACKGROUND

During use of tablets, some users often install cases outside the tablets to protect the tablets. However, during use of the existing tablet case, a side cover for protecting a screen of a tablet will occupy an additional space, and the side cover is often integrated with a shell for protecting a tablet main body. As a result, it is difficult for a user to remove the side cover alone and only use the tablet with the case, so that users' demands are hard to meet.

### SUMMARY

The present disclosure aims to provide a tablet case to solve the shortcomings in the prior art.

In order to achieve the above objective, the present disclosure adopts the following technical solution: A tablet case includes a case body and a soft rubber side cover; a buckle cover is mounted on a surface of the case body; an insertion slot is formed in an outer side of the case body; an extension plate is fixedly arranged on a surface of the soft rubber side cover; one side of the extension plate is fixedly provided with an insertion rod; and the insertion rod and the extension plate are inserted into the insertion slot.

In order to make the soft rubber side cover be able to achieve a better protection effect, in an improvement of the present disclosure, hard rubber strips are fixedly arranged on the surface of the soft rubber side cover; and the hard rubber strips are distributed in an equal spacing manner.

In order to facilitate storing accessories, in an improvement of the present disclosure, an accommodating bag is fixedly arranged on a surface of one group of hard rubber strip.

In order to facilitate rotating the soft rubber side cover, in an improvement of the present disclosure, a pick is fixedly arranged on the surface of the soft rubber side cover.

In order to make a tablet more stable, in an improvement of the present disclosure, a foam pad is fixedly arranged inside the case body; and the foam pad is symmetrically distributed.

In order to facilitating holding the case body, in an improvement of the present disclosure, antiskid lines are arranged on the surface of the case body.

Compared with the prior art, the present disclosure has the advantages and beneficial effects:

According to the present disclosure, by means of the arrangement of the insertion rod, to remove the soft rubber side cover and use the case body alone, a user simply pulls the extension plate, withdraws the insertion rod from the insertion slot, removes the soft rubber side cover, and use the case body alone. In addition, to mount the soft rubber side cover again, the user simply inserts the insertion rod into the insertion slot and can use the soft rubber side cover again. The whole process is easy and fast, and the tablet case is convenient to use and can meet a use demand of the user.

### BRIEF DESCRIPTION OF THE DRAWINGS

FIG. 1 is a schematic structural diagram of a closed state of a tablet case provided by the present disclosure;

FIG. 2 is a schematic structural diagram of a front view of an opened state of a tablet case provided by the present disclosure;

FIG. 3 is a schematic structural diagram of a rear view of an opened state of a tablet case provided by the present disclosure;

FIG. 4 is a schematic structural diagram of a soft rubber side cover of a tablet case provided by the present disclosure and removal of the side cover; and

FIG. 5 is a schematic structural diagram of part A in FIG. 4 of a tablet case provided by the present disclosure.

### ILLUSTRATIONS IN THE DRAWINGS

1: case body; 2: soft rubber side cover; 3: buckle cover; 4: insertion slot; 5: extension plate; 6: insertion rod; 7: hard rubber strip; 8: accommodating bag; 9: pick; and 10: foam pad.

### DETAILED DESCRIPTION OF THE EMBODIMENTS

In order to understand the above objectives, features and advantages of the present disclosure more clearly, the present disclosure will be further described below with reference to the accompanying drawings and embodiments. It should be noted that the embodiments of the present disclosure and features in the embodiments may be combined with each other without conflicts.

In the description of the present disclosure, it should be understood that orientations or positional relationships indicated by the terms “length”, “width”, “upper”, “lower”, “front”, “rear”, “left”, “right”, “vertical”, “horizontal”, “top”, “bottom”, “inside”, “outside” and the like are orientations or positional relationships as shown in the drawings, and are only for the purpose of facilitating and simplifying the description of the present disclosure instead of indicating or implying that devices or elements indicated must have particular orientations, and be constructed and operated in the particular orientations, so that these terms are not construed as limiting the present disclosure. In the description of the present disclosure, unless expressly specified otherwise, the meaning of the “plurality” is two or more than two.

### Embodiment

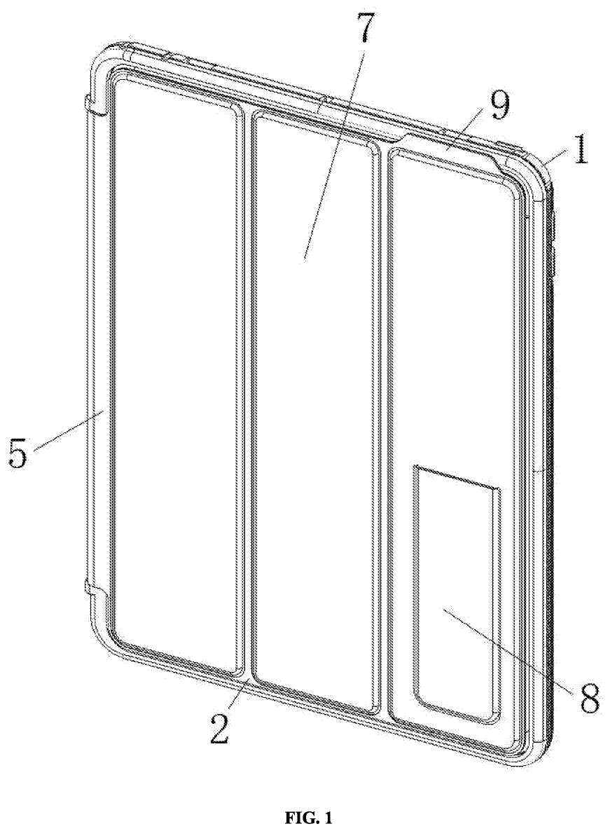

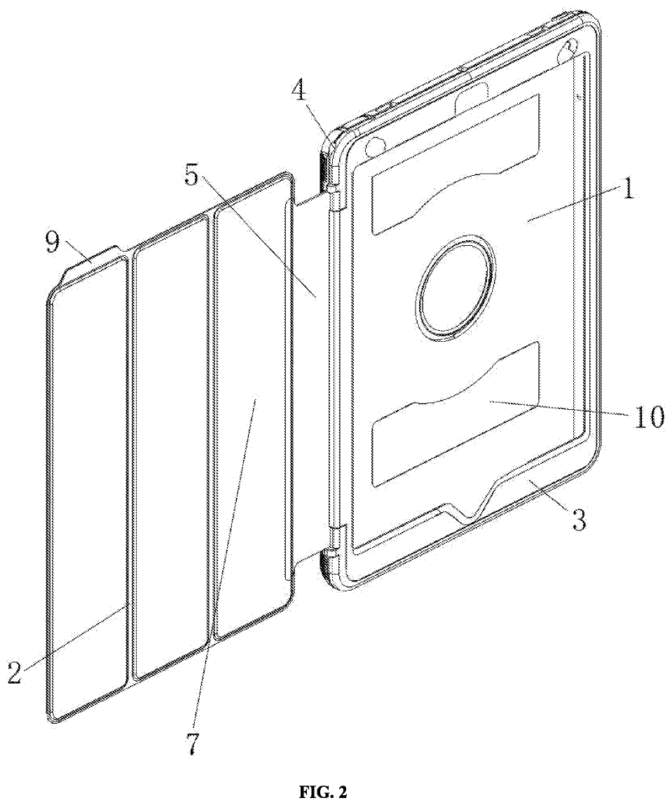

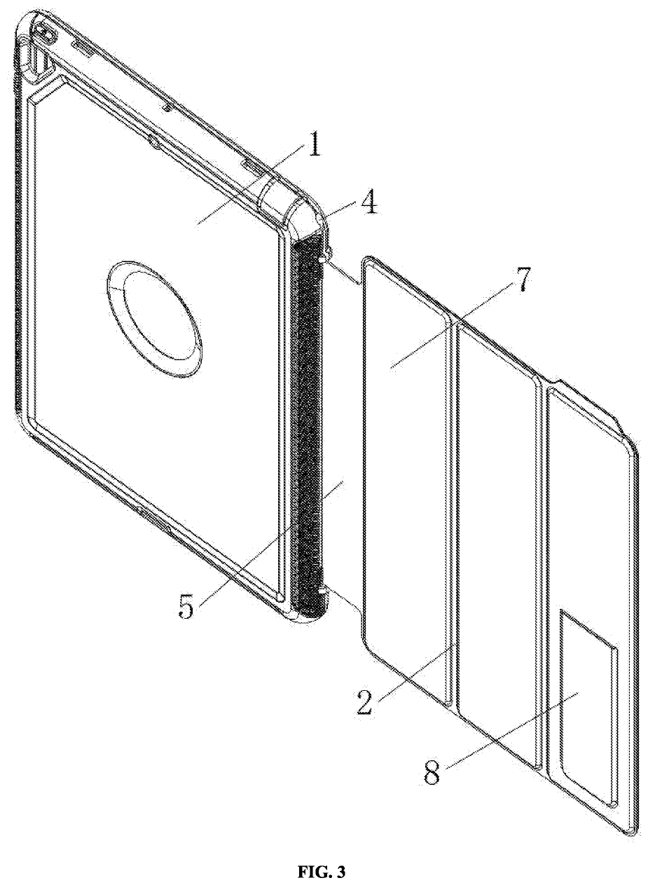

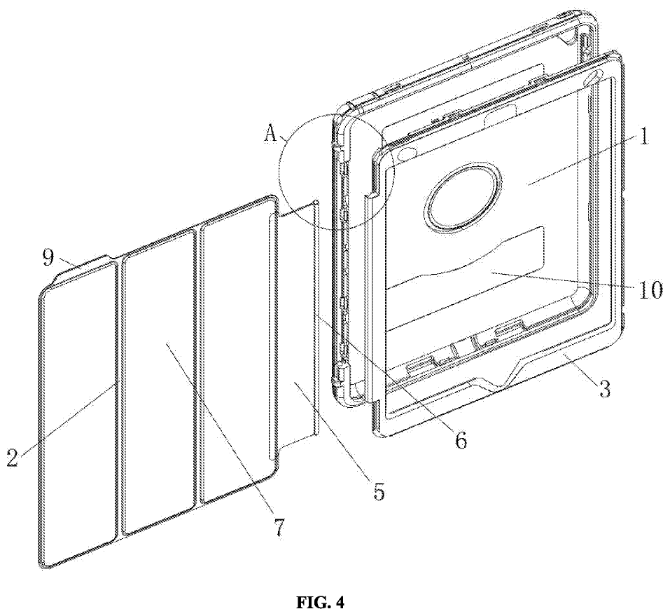

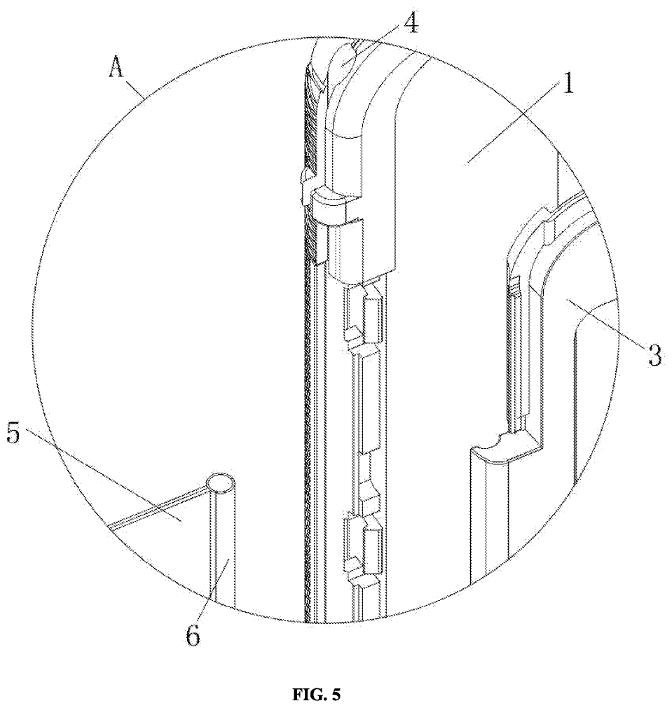

As shown in FIG. 1 to FIG. 5, in a technical solution provided by the present disclosure: A tablet case includes a case body 1 and a soft rubber side cover 2. A buckle cover 3 is mounted on a surface of the case body 1. The case body 1 is a common tablet case on the market, and its specific working principle and use method are common general knowledge of those skilled in the art, so the case body is not excessively described herein. An insertion slot 4 is formed in an outer side of the case body 1. An extension plate 5 is fixedly arranged on a surface of the soft rubber side cover 2. One side of the extension plate 5 is fixedly provided with an insertion rod 6. The insertion rod 6 and the extension plate 5 are inserted into the insertion slot 4. To remove the soft rubber side cover 2 and use the case body 1 alone, a user simply pulls the extension plate 5, withdraws the insertion rod 6 from the insertion slot 4, removes the soft rubber side cover 2, and use the case body 1 alone. In addition, to mount the soft rubber side cover 2 again, the user simply inserts the insertion rod 6 into the insertion slot 4 and can reuse the soft rubber side cover 2. The whole process is easy and fast, and the tablet case is convenient to use and can meet a use demand of the user.

As shown in FIG. 1 to FIG. 5, hard rubber strips 7 are fixedly arranged on the surface of the soft rubber side cover 2. The hard rubber strips 7 are distributed in an equal spacing manner. The hard rubber strips 7 can improve the strength of the soft rubber side cover 2, so that a screen of the tablet can be better protected. An accommodating bag 8 is fixedly arranged on a surface of one group of hard rubber strip 7. The accommodating bag 8 can facilitate the user to store and place a thimble or a memory card or other components for later use. A pick 9 is fixedly arranged on the surface of the soft rubber side cover 2. The pick 9 can facilitate the user to push the soft rubber side cover 2 to rotate, thus turning on the tablet for use. A foam pad 10 is fixedly arranged inside the case body 1. The foam pad 10 is symmetrically distributed. The foam pad 10 can be fitted to the tablet and make the table more table. Antiskid lines are arranged on the surface of the case body 1. The antiskid lines can increase friction between the hand and the case body 1, so that it is convenient for the user to hold the case body 1.

The working principle is as follows: During use, the user can remove the buckle cover 3, then put a tablet with a corresponding model number into the case body 1, and buckle the buckle cover 3 on the case body 1 to restrain the tablet in the case body 1, so that the tablet can be protected by the case body 1 in the use process. The foam pad 10 can be fitted to the tablet to make the tablet more stable. The antiskid lines can increase the friction between the hand and the case body 1, so that it is convenient for the user to hold the case body 1. Furthermore, by means of bending the extension plate 5, the user can flip the soft rubber side cover 2 to cover the surface of the tablet, so that the soft rubber side cover 2 can protect the screen of the tablet when the tablet is stored. The hard rubber strips 7 can improve the strength of the soft rubber side cover 2, so that the screen of the tablet can be better protected. The accommodating bag 8 can facilitate the user to store and place a thimble or a memory card or other components for later use. The pick 9 can facilitate the user to push the soft rubber side cover 2 to rotate, thus turning on the tablet for use. To remove the soft rubber side cover 2 and use the case body 1 alone, the user simply pulls the extension plate 5, withdraws the insertion rod 6 from the insertion slot 4, removes the soft rubber side cover 2, and use the case body 1 alone. In addition, to mount the soft rubber side cover 2 again, the user simply inserts the insertion rod 6 into the insertion slot 4 and can use the soft rubber side cover 2 again.

Only preferred embodiments of the present disclosure are described above, and are not intended to limit the present disclosure in other forms. Anyone skilled in the art can change or modify the technical content disclosed above into equivalently changed equivalent embodiments which are applied to other fields. However, any simple alterations, equivalent changes and modifications made to the above embodiments according to the technical essence of the present disclosure without departing from the content of the technical solutions of the present disclosure still fall within the protection scope of the technical solutions of the present disclosure.

What is claimed is:

1. A tablet case, comprising a case body (1) and a soft rubber side cover (2), wherein a buckle cover (3) is mounted on a surface of the case body (1); an insertion slot (4) is formed in an outer side of the case body (1); an extension plate (5) is fixedly arranged on a surface of the soft rubber side cover (2); one side of the extension plate (5) is fixedly provided with an insertion rod (6); and the insertion rod (6) and the extension plate (5) are inserted into the insertion slot (4).

2. The tablet case according to claim 1, wherein hard rubber strips (7) are fixedly arranged on the surface of the soft rubber side cover (2); and the hard rubber strips (7) are distributed in an equal spacing manner.

3. The tablet case according to claim 2, wherein an accommodating bag (8) is fixedly arranged on a surface of one group of hard rubber strip (7).

4. The tablet case according to claim 1, wherein a pick (9) is fixedly arranged on the surface of the soft rubber side cover (2).

5. The tablet case according to claim 1, wherein a foam pad (10) is fixedly arranged inside the case body (1); and the foam pad (10) is symmetrically distributed.

6. The tablet case according to claim 1, wherein antiskid lines are arranged on the surface of the case body (1).
